(19) United States
(12) Patent Application Publication
(10) Pub. No.: US 2012/0310480 A1
(43) Pub. Date: Dec. 6, 2012

(54) METHOD FOR OPERATING A DRIVER ASSISTANCE SYSTEM OF A MOTOR VEHICLE AND DRIVER ASSISTANCE SYSTEM FOR A MOTOR VEHICLE

(75) Inventor: Gerald SCHMIDT, Frankfurt/Main (DE)

(73) Assignee: GM GLOBAL TECHNOLOGY OPERATIONS LLC, Detroit, MI (US)

(21) Appl. No.: 13/481,337

(22) Filed: May 25, 2012

(30) Foreign Application Priority Data
May 31, 2011 (DE) 10 2011 102 927.7

(51) Int. Cl. B62D 6/04; B60T 7/12; B62D 6/00

(52) U.S. Cl. 701/41

(57) ABSTRACT

A method for operating a driver assistance system of a vehicle, wherein the system is configured for the automatic actuation of an element chosen from a braking device, a drive device, a steering device and a warning device, is provided. The method includes determining a first parameter characterizing a possible collision of the motor vehicle with an object situated in front of the vehicle in the direction of travel of the vehicle. A second parameter chosen from an instantaneous transverse acceleration, an instantaneous yaw rate, an instantaneous chronological alteration of the transverse acceleration, and an instantaneous chronological alteration of the yaw rate, all of the motor vehicle, is determined. If the second parameter does not exceed a predetermined threshold value, an automatic actuation takes place of the element and if the second parameter exceeds the predetermined threshold value, an automatic actuation of the element of the motor vehicle is omitted.

### CROSS-REFERENCE TO RELATED APPLICATION

This application claims priority to German Patent Application No. 10 2011 102 927.7, filed May 31, 2011, which is incorporated herein by reference in its entirety.

### TECHNICAL FIELD

The technical field generally relates to a method for operating a driver assistance system of a motor vehicle, a driver assistance system for a motor vehicle, a computer program product and a computer-readable medium.

### BACKGROUND

From US Patent Publication No. 2007/0164852 A1, a lane departure detection/avoidance and data fusion system is known, which is configured for use in a vehicle and by an operator. The system has at least one lane-marking sensor, at least one condition sensor and a controller which is communicatively coupled with the sensors and configured to determine a condition deviation, and compare the condition deviation with a predetermined condition threshold, so as to improve system identification of operator engagement, lane departure detection upon curves, and detection of performance degradation.

It is at least one object herein to provide a method for operating a driver assistance system of a motor vehicle, a driver assistance system for a motor vehicle, a computer program product and a computer-readable medium, which enable a further improved operation of the driver assistance system. In addition, other objects, desirable features and characteristics will become apparent from the subsequent summary and detailed description, and the appended claims, taken in conjunction with the accompanying drawings and this background.

### SUMMARY

A method for operating a driver assistance system of a motor vehicle is provided. In an embodiment, the driver assistance system is configured for the automatic actuation of an element of the motor vehicle, chosen from a braking device, a drive device, a steering device and a warning device. In accordance with the system, a determining takes place at least of a first parameter characterizing a possible collision of the motor vehicle with an object situated in front of the motor vehicle in the direction of travel of the motor vehicle. In addition, a determining takes place of a second parameter, wherein the second parameter is chosen from an instantaneous transverse acceleration of the motor vehicle, an instantaneous yaw rate of the motor vehicle, an instantaneous chronological alteration of the transverse acceleration of the motor vehicle, and an instantaneous chronological alteration of the yaw rate of the motor vehicle. Here and in the following, the respective determined value is understood to mean the absolute amount or respectively absolute value of the corresponding quantity. Furthermore, a determining takes place as to whether a collision of the motor vehicle with the object is imminent based on the determined first parameter. Moreover, a determining takes place as to whether the second parameter exceeds a predetermined threshold value. In the event that the at least one second parameter does not exceed the predetermined threshold value, an automatic actuation takes place of the element of the motor vehicle. In the event that the second parameter exceeds the predetermined threshold value, an automatic actuation of the element of the motor vehicle is omitted.

The method according to an embodiment enables a further improved operation of the driver assistance system. This takes place by the determining of the second parameter, the determining as to whether the second parameter exceeds the predetermined threshold value and the omission of the automatic actuation of the element in the event that the second parameter exceeds the predetermined threshold value. The application proceeds here from the consideration that the automatic actuation of the element can be omitted under the condition, because the exceeding of the predetermined threshold value suggests that a driver of the motor vehicle is already carrying out a steering- or respectively avoidance maneuver, in order to prevent the possible impending collision of the vehicle with the object or respectively that the situation concerns an overtaking maneuver of the vehicle, in which the latter has moved close to the object. In these situations, the issuing of a warning message or respectively an autonomous intervention into the driving dynamics of the motor vehicle by means of the driver assistance system can therefore be omitted. The method according to an embodiment enables false alarms or respectively false activations of the driver assistance system to be avoided.

Furthermore, the determining of the second parameter can be carried out repeatedly and a determining of a mean value of the second parameter, i.e. an averaging, can take place. In this arrangement, it is determined whether the mean value of the second parameter exceeds the predetermined threshold value. Thereby, the influence of any measurement errors of individual measurement values which may be present can be reduced. Furthermore, the arrangement is particularly suitable if a measurement signal for determining the second parameter has a relatively high noise or respectively a high noise level.

The determining as to whether the second parameter exceeds the predetermined threshold value takes place if it is determined that a collision of the motor vehicle with the object is imminent. Thereby, the determining as to whether an intended steering- or respectively avoidance maneuver is being carried out by the driver can be limited to the situation and the method can thereby be carried out in a simple manner.

In an embodiment, the driver assistance system is configured as a front collision warning system, which is also designated as a forward collision alert (FCA) or, respectively, as a forward collision warning or as a front collision warning (FCW). In this embodiment, the at least one element of the motor vehicle is a warning device. An issuing of a warning message by means of the warning device is omitted in the event of the second parameter exceeding the predetermined threshold value.

In a further embodiment, the driver assistance system is configured as an automatic emergency brake system, which is also designated as collision imminent braking (CIB). In the embodiment which is shown, the driver assistance system is therefore an intervening, autonomously braking system. In this embodiment, the element of the motor vehicle is a braking device. An automatic actuation of the braking device is omitted in the event that the second parameter exceeds the predetermined threshold value.

Furthermore, the driver assistance system can be configured as a distance control system, which is also designated as adaptive cruise control (ACC). In this embodiment, with an activated distance control system i.e., with a distance control by the system, an issuing of a takeover request to the driver of the motor vehicle by the warning device is omitted in the event that the second parameter exceeds the predetermined threshold value.

The above-mentioned driver assistance systems concern respectively a so-called longitudinal driver assistance system, i.e. a driver assistance system which is designed for driving situations which relate to the instantaneous travel direction of the motor vehicle.

In a further embodiment, the first parameter is a time-to-collision value, which is also designated as TCC value. This value indicates here the duration which would remain, with unaltered driving dynamics of the motor vehicle, up to a collision with the object. In this embodiment, the determining as to whether a collision of the motor vehicle with the object is imminent contains a determining as to whether the time-to-collision value falls below a second predetermined threshold value.

The second predetermined threshold value is determined, for example, as a function of an instantaneous relative speed of the motor vehicle to the object. Thereby, the driver assistance system can be adapted to the respective driving situation to a further improved extent.

Furthermore, the first parameter can contain a deceleration value of the motor vehicle which is required for avoiding the collision. This value indicates the deceleration or respectively braking of the motor vehicle which would be required in order to avoid a collision with the object. In this embodiment, the determining as to whether a collision of the motor vehicle with the object is imminent contains a determining as to whether the required deceleration value exceeds a third predetermined threshold value.

The third predetermined threshold value can in addition contain a predetermined value of a reaction time of the driver of the motor vehicle or a predetermined value of a dead time of the driver assistance system.

The above-mentioned parameters are suitable here to a particularly high extent for determining whether a collision of the motor vehicle with the object is imminent.

In addition, a determining of a third parameter can take place, wherein the third parameter is selected from the group consisting of an instantaneous steering wheel angle and an instantaneous steering wheel angle speed. A decision as to whether an automatic actuation of the element takes place or is omitted, takes place in this arrangement in addition based on the determined third parameter. In this arrangement therefore a fusion of sensor data takes place or respectively a reciprocal plausibility analysis of the parameters, whereby a further improved operation of the driver assistance system can be enabled.

In embodiments in which the second parameter is the instantaneous transverse acceleration of the motor vehicle, the predetermined threshold value is preferably about 4 m/s². If the second parameter is the instantaneous chronological alteration of the transverse acceleration of the motor vehicle, the predetermined threshold value is preferably about 5 m/s².

In embodiments in which the second parameter is the instantaneous yaw rate of the motor vehicle, the predetermined threshold value is preferably 10° s⁻¹. If the second parameter is the instantaneous chronological alteration of the yaw rate of the motor vehicle, the predetermined threshold value is preferably 10° s⁻².

In another embodiment, a driver assistance system for a motor vehicle is provided. The driver assistance system has a first determining device which is configured for determining a first parameter characterizing a possible collision of the motor vehicle with an object situated in front of the motor vehicle in the direction of travel of the motor vehicle. In addition, the driver assistance system has a second determining device, configured to determine at least a second parameter, wherein the second parameter is chosen from an instantaneous transverse acceleration of the motor vehicle, an instantaneous yaw rate of the motor vehicle, an instantaneous chronological alteration of the transverse acceleration of the motor vehicle, and an instantaneous chronological alteration of the yaw rate of the motor vehicle. Furthermore, the driver assistance system has a third determining device, which is configured for determining whether a collision of the motor vehicle with the object is imminent, based on the determined first parameter. In addition, the driver assistance system has a fourth determining device, configured for determining whether the second parameter exceeds a predetermined threshold value. The driver assistance system has in addition an actuating device which is configured for the automatic actuation of the element of the motor vehicle, chosen from a braking device, a drive device, a steering device and a warning device. Moreover, the driver assistance system has a decision device configured to decide whether an automatic actuation of the element by the actuating device takes place or is omitted. An automatic actuation of the element of the motor vehicle takes place here in the event that the second parameter does not exceed the predetermined threshold value. On the other hand, in the event that the second parameter exceeds the predetermined threshold value, an automatic actuation of the element of the motor vehicle is omitted.

In an embodiment, a computer program product is provided which, when it is executed on a processing unit of a driver assistance system of a motor vehicle, wherein the driver assistance system is configured for the automatic actuation an element of the motor vehicle, chosen from a braking device, a drive device, a steering device and a warning device, instructs the processing unit to carry out the following steps. The processing unit is instructed for determining a first parameter characterizing a possible collision of the motor vehicle with an object situated in front of the motor vehicle in the direction of travel of the motor vehicle. In addition, the processing unit is instructed for determining a second parameter, wherein the second parameter is chosen from an instantaneous transverse acceleration of the motor vehicle, an instantaneous yaw rate of the motor vehicle, an instantaneous chronological alteration of the transverse acceleration of the motor vehicle and an instantaneous chronological alteration of the yaw rate of the motor vehicle. Moreover, the processing unit is instructed for the determining as to whether a collision of the motor vehicle with the object is imminent, based on the determined first parameter. Furthermore, the processing unit is instructed for determining whether the second parameter exceeds a predetermined threshold value. In the event that the second parameter does not exceed the predetermined threshold value, the processing unit is instructed for the automatic actuation of the element of the motor vehicle by means of the driver assistance system. In the event that the second parameter exceeds the predetermined threshold value, an automatic actuation of the element of the motor vehicle is omitted.

The application further relates to a computer-readable medium on which a computer program product according to the embodiment is stored.

In the above-mentioned embodiments, the motor vehicle is, for example, an automobile or a truck.

### BRIEF DESCRIPTION OF THE DRAWINGS

The various embodiments will hereinafter be described in conjunction with the following drawing figures, wherein like numerals denote like elements, and wherein:

FIG. 1 shows a flow diagram of a method for operating a driver assistance system of a motor vehicle according to a first embodiment;

FIG. 2 shows a flow diagram of a method for operating a driver assistance system of a motor vehicle according to another embodiment;

FIG. 3 shows an example of a traffic situation in which the method according to an embodiment can be used; and

FIG. 4 shows a driver assistance system of the first vehicle shown in FIG. 3 according to an embodiment.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

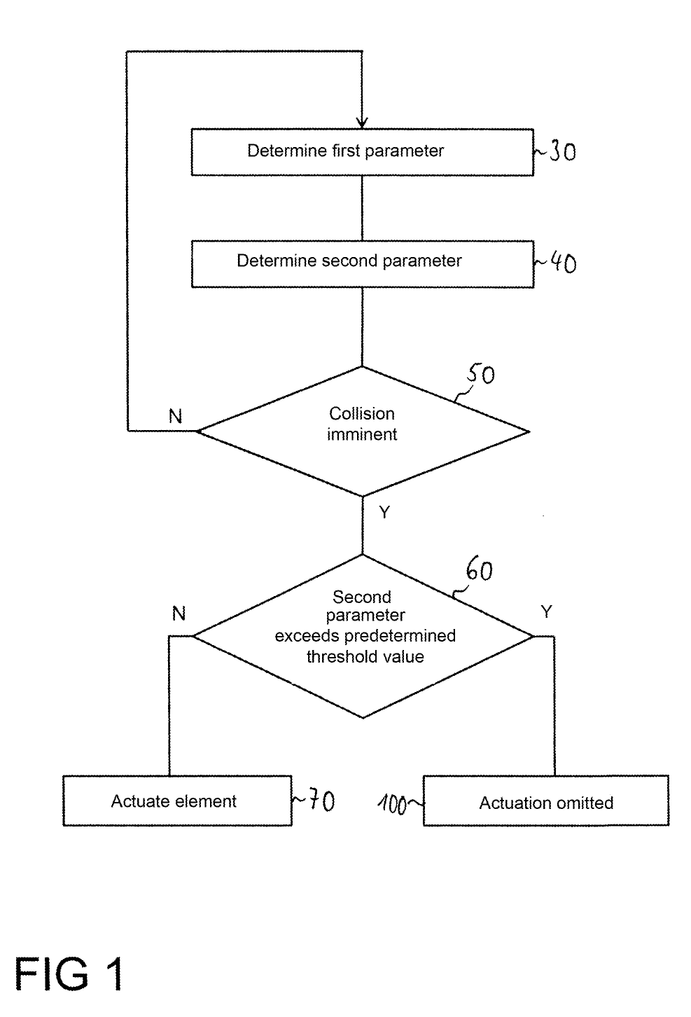

FIG. 1 shows a flow diagram of a method for operating a driver assistance system of a motor vehicle according to an embodiment. The driver assistance system is configured here for the automatic actuation of an element of the motor vehicle, chosen from a braking device, a drive device, a steering device and a warning device. For example, the driver assistance system is configured as a front collision warning system, as an automatic emergency braking system or as a distance control system of the motor vehicle. The motor vehicle is, for example, an automobile or a truck.

In a step 30 a determining takes place of a first parameter characterizing a possible collision of the motor vehicle with an object situated in front of the motor vehicle in the direction of travel of the motor vehicle. The first parameter can be a time-to-collision value. This is a particularly suitable parameter in particular for driver assistance systems which are configured as a front collision warning system or as an automatic emergency braking system. Furthermore, the first parameter can contain a deceleration value which is required for avoiding the collision. This can be determined from the instantaneous distance and the instantaneous speed of the motor vehicle relative to the object.

In a step 40 a determining takes place of a second parameter, wherein the second parameter is chosen from an instantaneous transverse acceleration of the motor vehicle, an instantaneous yaw rate of the motor vehicle, an instantaneous chronological alteration of the transverse acceleration of the motor vehicle, and an instantaneous chronological alteration of the yaw rate of the motor vehicle.

In a step 50 a determining takes place as to whether a collision of the motor vehicle with the object is imminent, based on the determined first parameter.

The determining as to whether a collision of the motor vehicle with the object is imminent contains for example a determining as to whether the time-to-collision value falls below a second predetermined threshold value. The second predetermined threshold value can be determined as a function of an instantaneous relative speed of the motor vehicle to the object.

The time-to-collision value in a front collision warning system is, for example, in the range of approximately 1.2 seconds (s) to approximately 3.0 s. In a fully automatic emergency braking system, the second predetermined threshold value, dependent on the relative speed, can be for example in the range of about 0.8 s with a relative speed up to a maximum of about 10 km/h to about 3 s with a relative speed of, for example, about 100 km/h.

Furthermore, the determining as to whether a collision of the motor vehicle with the object is imminent can contain a determining as to whether the required deceleration value exceeds a third predetermined threshold value. The third predetermined threshold value can contain in addition a predetermined value of a reaction time or a predetermined value of a dead time of the driver assistance system.

For example, the third predetermined threshold value in a front collision warning system is about 5 m/s², wherein in addition a reaction time of the driver of one second is included. In an automatic emergency braking system, the third predetermined threshold value is, for example, about 6 m/s², wherein in addition a system dead time of about 300 ms to about 700 ms is taken into consideration for the build-up of the necessary brake pressure.

If it is determined in step 50 that a collision of the motor vehicle with the object is not imminent, steps 30, 40 and 50 are carried out repeatedly.

If, on the other hand, it is determined in step 50 that a collision of the motor vehicle with the object is imminent, it is determined in a step 60 whether the second parameter exceeds a predetermined threshold value.

In the event that the second parameter is the instantaneous transverse acceleration of the motor vehicle, the predetermined threshold value is, for example, about 3.5 m/s² or about 4 m/s². If the second parameter is the instantaneous chronological alteration of the transverse acceleration of the motor vehicle, the predetermined threshold value is, for example, about 5 m/s². In the event that the second parameter is the instantaneous yaw rate of the motor vehicle, the predetermined threshold value is, for example, about 10° s⁻¹. If the second parameter is the instantaneous chronological alteration of the yaw rate of the motor vehicle, the predetermined threshold value is, for example, 10° s⁻².

In configurations in which both the instantaneous transverse acceleration of the motor vehicle and also the instantaneous yaw rate of the motor vehicle are determined, in step 60 preferably firstly it is determined whether the instantaneous yaw rate exceeds the predetermined threshold value, because the value of the instantaneous yaw rate can be typically determined earlier than the value of the instantaneous transverse acceleration or respectively this value already alters significantly earlier in a steering maneuver than the value of the instantaneous transverse acceleration. The same applies in the event that respectively the chronological alterations to the values are determined.

In the event that the second parameter does not exceed the predetermined threshold value, in a step 70 an automatic actuation of the element of the motor vehicle takes place.

In the event that, on the other hand, the second parameter exceeds the predetermined threshold value, an automatic action of the element of the motor vehicle is omitted, as is represented in a step 100. For example, an issuing of a warning message by the warning device is omitted in the event that the driver assistance system is configured as a front collision warning system. In the event that the driver assistance system is configured as an automatic emergency braking system, an automatic actuation of the braking device is omitted. If the driver assistance system is configured as a distance control system, in the step an issuing of a take-over request to the driver of the motor vehicle by the warning device is omitted.

In a further embodiment, the determining takes place as to whether a collision of the motor vehicle with the object is imminent before the determining of the second parameter, i.e. steps 40 and 50 are carried out in reverse order.

The vehicle dynamics parameters of transverse acceleration and yaw rate or respectively the chronological alterations thereof are suited to a particularly great extent to determine whether a deliberate steering- or respectively avoidance maneuver is being carried out by the driver of the motor vehicle. The consideration is proceeded from here that the driver of the motor vehicle controls or respectively handles lateral maneuvers, i.e. maneuvers transversely to the direction of travel of the motor vehicle, by the occurring yaw rate or respectively transverse acceleration. The values taken into consideration by the driver, i.e. yaw rate or respectively transverse acceleration, are driver- and maneuver-specific here, but typically independent of the type of motor vehicle. Therefore, a determining of a suppression threshold value by these vehicle dynamic parameters or respectively the chronological alterations thereof is possible independently of the vehicle. A determining of this threshold value is therefore necessary only once for all motor vehicles within a vehicle type, for example automobiles, trucks or transporters. Thereby, a continuous calibration effort can be dispensed with and a standardization of the required algorithms can take place. This leads to a saving on costs.

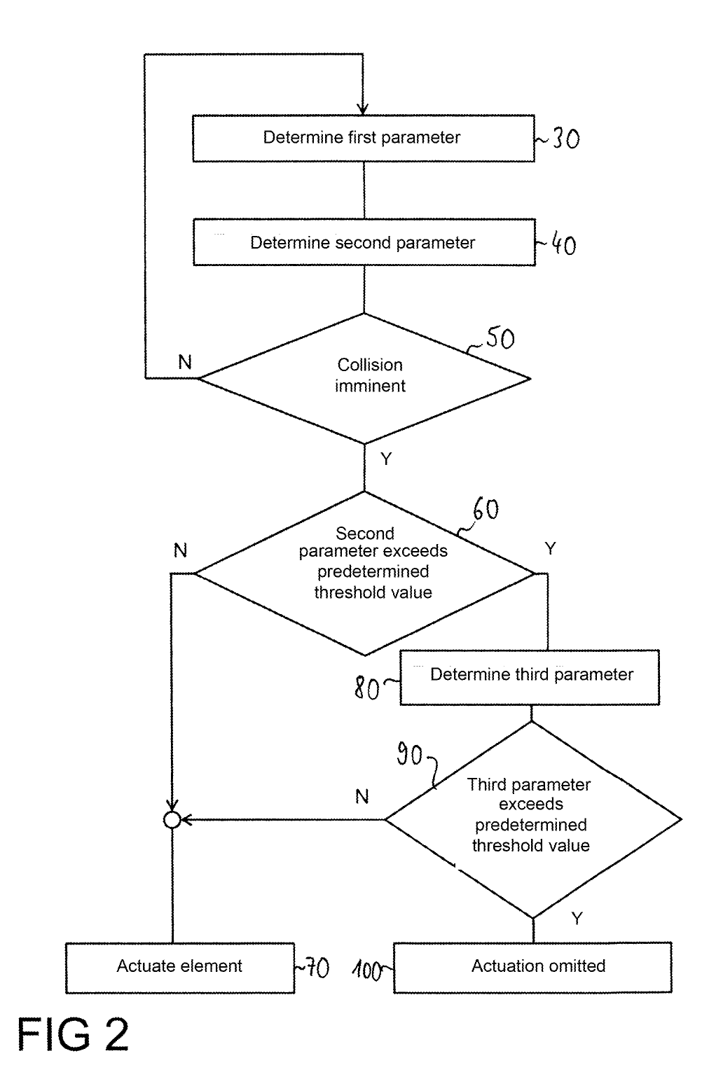

FIG. 2 shows a flow diagram of a method for operating a driver assistance system of a motor vehicle according to another embodiment. The driver assistance system is again configured for the automatic actuation the element of the motor vehicle, chosen from a braking device, a drive device, a steering device and a warning device. The motor vehicle is, for example, an automobile or a truck.

In the embodiment which is shown, in a step 30 a determining takes place of a first parameter characterizing a possible collision of the motor vehicle with an object situated in front of the motor vehicle in the direction of travel of the motor vehicle, in accordance with step 30 of the first embodiment shown in FIG. 1. Furthermore, in a step 40 a determining takes place of a second parameter, wherein the second parameter is chosen from an instantaneous transverse acceleration of the motor vehicle, an instantaneous yaw rate of the motor vehicle, an instantaneous chronological alteration of the transverse acceleration of the motor vehicle, and an instantaneous chronological alteration of the yaw rate of the motor vehicle, corresponding to the step 40 of the first embodiment shown in FIG. 1. In addition, in a step 50 a determining takes place as to whether a collision of the motor vehicle with the object is imminent, based on the determined first parameter and, in the event that it is determined that a collision of the motor vehicle with the object is imminent, in a step 60 a determining takes place as to whether the second parameter exceeds a predetermined threshold value, corresponding to steps 50 and 60 of the first embodiment shown in FIG. 1.

In the event that the second parameter does not exceed the predetermined threshold value, an automatic actuation takes place of the element of the motor vehicle in a step 70, which corresponds to step 70 of the first embodiment.

In the event that the second parameter exceeds the predetermined threshold value, in a step 80 in the embodiment which is shown, a determining takes place of a third parameter, wherein the third parameter is chosen from an instantaneous steering wheel angle and an instantaneous steering wheel angle speed.

In a step 90 it is determined as to whether the third parameter exceeds a predetermined threshold value.

In the event that the third parameter does not exceed the predetermined threshold value, in a step 70 again an automatic actuation takes place of the element of the motor vehicle.

In the event that, on the other hand, the third parameter exceeds the predetermined threshold value, an automatic actuation of the element of the motor vehicle is omitted, as is again represented by a step 100.

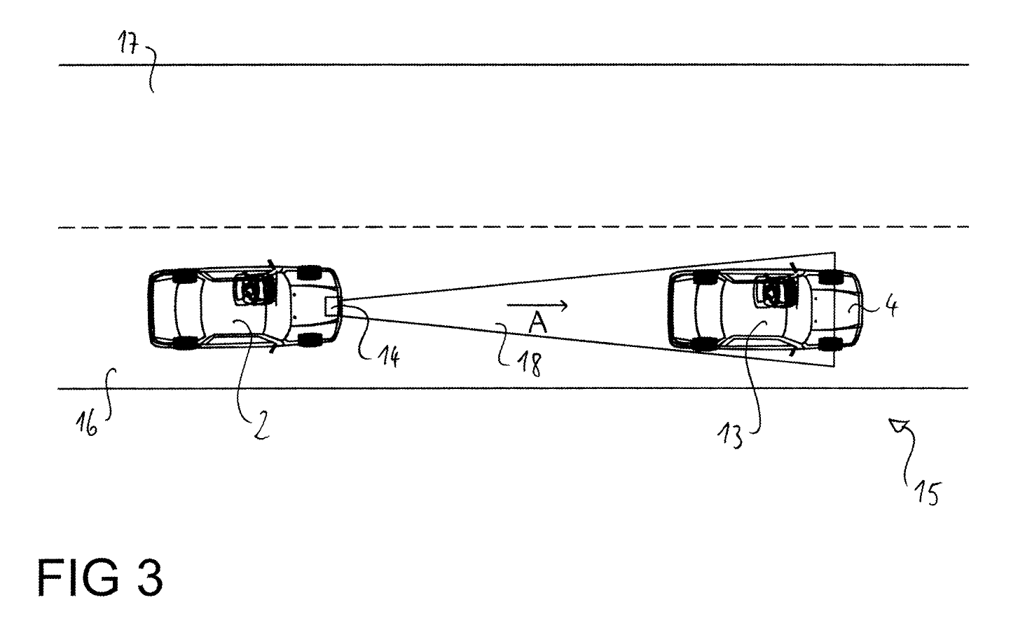

FIG. 3 shows an example of a traffic situation in which the methods according to various embodiments, in particular the methods according to the embodiments shown in FIGS. 1 and 2, can be used.

In the illustrated traffic situation, a first motor vehicle 2, which in the example shown is an automobile, is travelling in a direction of travel represented diagrammatically by an arrow A on a first lane 16 of a roadway 15. The roadway 15 has a further lane 17 adjacent to the first lane 16. In the direction of travel of the first motor vehicle 2 an object 4 is situated in front of the first motor vehicle 2 on the first lane 16. In the embodiment shown, the object 4 is formed by a second motor vehicle 13, travelling in the direction of travel of the first motor vehicle 2, which second motor vehicle is likewise an automobile.

The second motor vehicle 13 is situated at least partially within a diagrammatically represented detection range 18 of a sensor 14 of the first motor vehicle 2. In the embodiment shown, the sensor 14 is an electromagnetic sensor, for example a radar sensor or lidar sensor based on runtime. By measurement data determined by the sensor 14, thereby in particular a distance can be determined of the second motor vehicle 13 relative to the first motor vehicle 2 and in addition a speed of the second motor vehicle 13 relative to the first motor vehicle 2.

As will be explained in further detail in connection with the following figure, in the above-mentioned situations, in particular on overtaking maneuvers, the issuing of a warning message or respectively an autonomous intervention into the driving dynamics of the first motor vehicle 2 by a driver assistance system according to an embodiment can be omitted, and hence false alarms or respectively false activations of the driver assistance system are avoided.

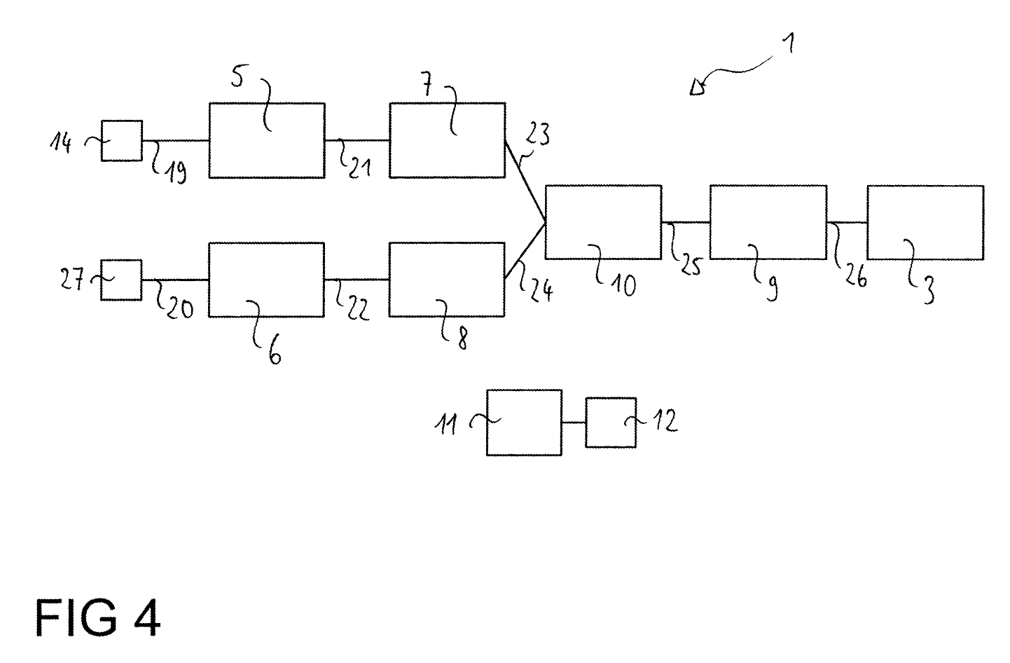

In addition, FIG. 4 shows a driver assistance system 1 of the first motor vehicle shown in FIG. 3 according to an embodiment. Components with the same functions as in FIG. 3 are designated by the same reference numbers and are not explained again below.

The driver assistance system 1 is configured for example as a front collision warning system, as an automatic emergency braking system, or as a distance control system. The driver assistance system 1 has a first determining device 5 which is configured for determining at least a first parameter characterizing a possible collision of the first motor vehicle with an object situated in front of the first motor vehicle in the direction of travel of the first motor vehicle. For this, the first determining device 5 in the embodiment which is shown is connected with the sensor 14 via a signal line 19.

Furthermore, the driver assistance system 1 has a second determining device 6 which is configured for determining a second parameter, wherein the second parameter is chosen from an instantaneous transverse acceleration of the first motor vehicle, an instantaneous yaw rate of the first motor vehicle, an instantaneous chronological alteration of the transverse acceleration of the motor vehicle, and an instantaneous chronological alteration of the yaw rate of the motor vehicle. For this, the second determining device 6 is connected with a correspondingly configured sensor 27 via a signal line 20. By data determined by the sensor 27, thereby the instantaneous transverse acceleration or respectively the instantaneous yaw rate of the first motor vehicle or respectively the chronological alterations thereof can be determined.

Moreover, the driver assistance system 1 has a third determining device 7, which is configured for determining whether a collision of the first motor vehicle with the object is imminent, based on the determined first parameter. For this, the third determining device 7 is connected with the first determining device 5 via a signal line 21.

Furthermore, the driver assistance system 1 has a fourth determining device 8, which is configured for determining whether the second parameter exceeds a predetermined threshold value. For this, the fourth determining device 8 is connected with the second determining device 6 via a signal line 22.

In addition, the driver assistance system 1 has an actuating device 9 which is configured for the automatic actuation of an element 3 of the motor vehicle, selected from the group consisting of a braking device, a drive device, a steering device and a warning device. For this, the actuating device 9 is connected with the element 3 via a control- and signal line 26.

Moreover, the driver assistance system 1 has a decision device 10, which is configured for deciding whether an automatic actuation of the element 3 takes place by the actuating device 9 or is omitted. For this, the decision device 10 is connected with the third determining device 7 via a signal line 23, and with the fourth determining device 8 via a signal line 24. Furthermore, the decision device 10 is connected with the actuating device 9 via a control- and signal line 25. In the event that the second parameter does not exceed the predetermined threshold value, an automatic actuation takes place of the element 3 of the first motor vehicle by the actuating device 9. In the event that, on the other hand, the second parameter exceeds the predetermined threshold value, an automatic actuation of the element 3 of the first motor vehicle is omitted.

In the embodiment which is shown, the driver assistance system 1 has in addition a processing unit 11 and a computer-readable medium 12, wherein on the computer-readable medium 12 a computer program product is stored which, when it is executed on the processing unit 11, instructs the processing unit 11 to carry out the steps named in connection with the embodiments of the methods, in particular the steps of the methods according to FIGS. 1 and 2, by the elements named there. For this, the processing unit 11 is connected directly or indirectly with the corresponding elements in a manner which not illustrated in further detail.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A method for operating a driver assistance system of a motor vehicle, wherein the driver assistance system is configured for an automatic actuation of an element of the motor vehicle chosen from a braking device, a drive device, a steering device and a warning device, and wherein the method comprises the steps of:
determining a first parameter characterizing a possible collision of the motor vehicle with an object situated in front of the motor vehicle in a direction of travel of the motor vehicle;
determining a second parameter, wherein the second parameter is chosen from an instantaneous transverse acceleration of the motor vehicle, an instantaneous yaw rate of the motor vehicle, an instantaneous chronological alteration of a transverse acceleration of the motor vehicle, and an instantaneous chronological alteration of a yaw rate of the motor vehicle;
determining whether a collision of the motor vehicle with the object is imminent, based on the first parameter; and
determining whether the second parameter exceeds a predetermined threshold value,
wherein, in an event that the second parameter does not exceed the predetermined threshold value, the automatic actuation takes place of the element of the motor vehicle and wherein, in an event that the second parameter exceeds the predetermined threshold value, the automatic actuation of the element of the motor vehicle is omitted.

2. The method according to claim 1, wherein the determining whether the second parameter exceeds the predetermined threshold value takes place in the event that it is determined that the collision of the motor vehicle with the object is imminent.

3. The method according to claim 1, wherein the driver assistance system is configured as a front collision warning system and wherein, in the event that the second parameter exceeds the predetermined threshold value, an issuing of a warning message by the warning device is omitted.

4. The method according to claim 1, wherein the driver assistance system is configured as an automatic emergency braking system and wherein, in the event that the second parameter exceeds the predetermined threshold value, the automatic actuation of the braking device is omitted.

5. The method according to claim 1, wherein the driver assistance system is configured as a distance control system and wherein, in the event that the second parameter exceeds the predetermined threshold value, an issuing of a takeover request by the warning device is omitted.

6. The method according to claim 1, wherein the first parameter is a time-to-collision value and wherein the determining whether the collision of the motor vehicle with the object is imminent contains a determining whether a time-to-collision value falls below a second predetermined threshold value.

7. The method according to claim 6, wherein the second predetermined threshold value is determined as a function of an instantaneous relative speed of the motor vehicle to the object.

8. The method according to claim 1, wherein the first parameter contains a deceleration value required for an avoidance of the collision and wherein the determining whether the collision of the motor vehicle with the object is imminent contains a determining whether the deceleration value exceeds a third predetermined threshold value.

9. The method according to claim 8, wherein the third predetermined threshold value contains in addition a predetermined value of a reaction time or a predetermined value of a dead time of the driver assistance system.

10. The method according to claim 1, further comprising determining a third parameter, wherein the third parameter is chosen from an instantaneous steering wheel angle and an instantaneous steering wheel angle speed, and wherein a decision takes place as to whether the automatic actuation of the element takes place or is omitted, in addition based on the third parameter.

11. The method according to claim 1, wherein the second parameter is the instantaneous transverse acceleration of the motor vehicle and wherein the predetermined threshold value is approximately 4 m/s² or wherein the second parameter is the instantaneous chronological alteration of the transverse acceleration of the motor vehicle and wherein the predetermined threshold value is approximately 5 m/s².

12. The method according to claim 1, wherein the second parameter is the instantaneous yaw rate of the motor vehicle and wherein the predetermined threshold value is approximately 10° s⁻¹ or wherein the second parameter is the instantaneous chronological alteration of the yaw rate of the motor vehicle and wherein the predetermined threshold value is preferably 10° s⁻².

13. A driver assistance system for a motor vehicle, having
a first determining device configured for the determining of a first parameter characterizing a possible collision of the motor vehicle with an object situated in front of the motor vehicle in a direction of travel of the motor vehicle
a second determining device configured for the determining of a second parameter, wherein the second parameter is chosen from an instantaneous transverse acceleration of the motor vehicle, an instantaneous yaw rate of the motor vehicle, an instantaneous chronological alteration of a transverse acceleration of the motor vehicle, and an instantaneous chronological alteration of a yaw rate of the motor vehicle;
a third determining device configured for determining whether a collision of the motor vehicle with the object is imminent, based on the first parameter;
a fourth determining device configured for determining whether the second parameter exceeds a predetermined threshold value;
an actuating device configured for an automatic actuation of an element of the motor vehicle chosen from a braking device, a drive device, a steering device, and a warning device; and
a decision device configured for deciding whether the automatic actuation of the element by the actuating device takes place or is omitted,
wherein, in an event that the second parameter does not exceed the predetermined threshold value, the automatic actuation takes place of the element of the motor vehicle and wherein, in an event that the second parameter exceeds the predetermined threshold value, the automatic actuation of the element of the motor vehicle is omitted.

14. A computer readable medium embodying a computer program product comprising a computer program that, when executed on a processing unit of a driver assistance system, wherein the driver assistance system is configured for an automatic actuation of an element of a motor vehicle, chosen from a braking device, a drive device, a steering device, and a warning device, is configured to:
determine a first parameter characterizing a possible collision of the motor vehicle with an object situated in front of the motor vehicle in a direction of travel of the motor vehicle;
determine a second parameter, wherein the second parameter is chosen from an instantaneous transverse acceleration of the motor vehicle, an instantaneous yaw rate of the motor vehicle, an instantaneous chronological alteration of a transverse acceleration of the motor vehicle, and an instantaneous chronological alteration of a yaw rate of the motor vehicle;
determining whether a collision of the motor vehicle with the object is imminent, based on the first parameter; and
determining whether the second parameter exceeds a predetermined threshold value;
wherein, in an event that the second parameter does not exceed the predetermined threshold value, the automatic actuation takes place of the element of the motor vehicle and wherein, in an event that the second parameter exceeds the predetermined threshold value, the automatic actuation of the element of the motor vehicle is omitted.
